(19) United States
(12) Patent Application Publication
(10) Pub. No.: US 2026/0366541 A1
(43) Pub. Date: Nov. 19, 2026

(54) Method Of Pressurizing A Floating Piston Accumulator

(71) Applicant: Advanced Suspension Technology LLC, Northville, MI (US)

(72) Inventors: Kenny BERWAERTS, Muizen (BE); Jonas HENDERICKX, Hasselt (BE); Frederik BALDONI, Borgloon (BE)

(21) Appl. No.: 19/753,538

(22) Filed: Jul. 24, 2026

Related U.S. Application Data
(62) Division of application No. 18/244,537, filed on Sep. 11, 2023.

(51) Int. Cl. F15B 1/24; F15B 1/02; F16F 9/32; F16F 13/00

(52) U.S. Cl. CPC F15B 1/24; F15B 1/021; F16F 9/3271; F16F 13/007; F15B 2201/31; F15B 2201/60; F16F 2226/04

(57) ABSTRACT

A method of pressurizing an accumulator for a damper includes positioning a housing, an end cap, and a floating piston within a chamber. The floating piston is positioned outside of an inner volume of the end cap. The method further includes supplying pressurized gas to the chamber. The pressurized gas enters the inner volume of the end cap through an open end of the end cap. The end cap and floating piston are moved relative to one another to insert the floating piston through the open end in sealing engagement with the end cap to define a pressurized gas chamber within the end cap. The end cap is connected to the housing. The open end of the end cap is placed in fluid communication with an internal cavity of the housing. The supply of pressurized gas to the chamber is ceased and the inner tube is connected to the housing.

### CROSS-REFERENCE TO RELATED APPLICATIONS

The present disclosure is a divisional of U.S. patent application Ser. No. 18/244,537 filed on Sep. 11, 2023. The entire disclosure of the application referenced above is incorporated herein by reference.

### FIELD

The disclosure generally relates to assembly techniques for gas filled accumulators. More particularly, a method of pressurizing a floating piston accumulator without utilizing a filling port is described.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Various machines have been equipped with energy storage devices that are selectively charged and discharged during operation. In one example, an automotive vehicle includes a damper coupled to a wheeled end. A pressurized gas accumulator is coupled to a liquid containing chamber of the damper. The accumulator includes a floating piston that separates a pressurized gas chamber from a liquid chamber that is in fluid communication with the liquid within the damper.

Existing gas over liquid accumulators are often pre-charged prior to vehicle operation. The pre-charging process includes providing a filling port that extends through an accumulator housing containing the floating piston. After accumulator is assembled, pressurized gas is input through the filling port. A plug or expander is fixed to the accumulator housing to seal off the filling port and contain the pressurized gas within the accumulator. While this arrangement has worked in the past, several opportunities for improvement exist. For example, the accumulator housing is typically reinforced or cast as having a substantially thicker wall section at the location of the filling port than at other locations on the housing. The extra thickness increases the cost and weight of the housing. Leaks may occur allowing pressurized gas to escape through the filling port if the plug or expander is compromised. Surface treatments such as anodizing are typically not preformed on the accumulator housing prior to insertion of the plug or expander to improve the sealing characteristics of the plug or expander after filling the accumulator with pressurized gas. It may be desirable to apply a surface treatment to the accumulator housing prior to assembly. Accordingly, a need in the art exists for an improved method of pressurizing a floating piston accumulator.

### SUMMARY

A method of pressuring an accumulator including an end cap and a floating piston comprises positioning the floating piston outside an inner volume of the end cap. Pressurized gas is supplied to the inner volume through an open end of the end cap. The floating piston is inserted through the open end in sealing engagement with the end cap to define a pressurized gas chamber within the end cap. The method further includes mechanically deforming the end cap to define a radially inwardly extending projection that restricts removal of the floating piston from the end cap.

An alternate method of pressurizing an accumulator for a damper comprises positioning a housing of the damper, an end cap and a floating piston within a chamber. The floating piston is positioned outside of an inner volume of the end cap. Pressurized gas is supplied to the chamber such that the pressurized gas enters the inner volume of the end cap through an open end of the end cap. The end cap and the floating piston are moved relative to one another to insert the floating piston through the open end in sealing engagement with the end cap to define a pressurized gas chamber within the end cap. The end cap is connected to the housing to place the open end of the end cap in fluid communication with an internal cavity of the housing. The supply of pressurized gas is ceased to the chamber. The inner tube is connected to the housing.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of an exemplary vehicle equipped with a damper constructed according to the disclosed method;

FIG. 2 is a fragmentary cross-sectional view of a damper equipped with an accumulator constructed in accordance with the method of pressurizing disclosed herein;

FIGS. 3A-3G depict steps of the method of pressurizing the floating piston accumulator;

FIGS. 4A-4F depict steps of an alternate method of pressuring a floating piston accumulator; and

FIGS. 5A-5C depict another alternate method of pressuring a floating piston accumulator.

In the drawings, reference numbers may be reused to identify similar and/or identical elements.

### DETAILED DESCRIPTION

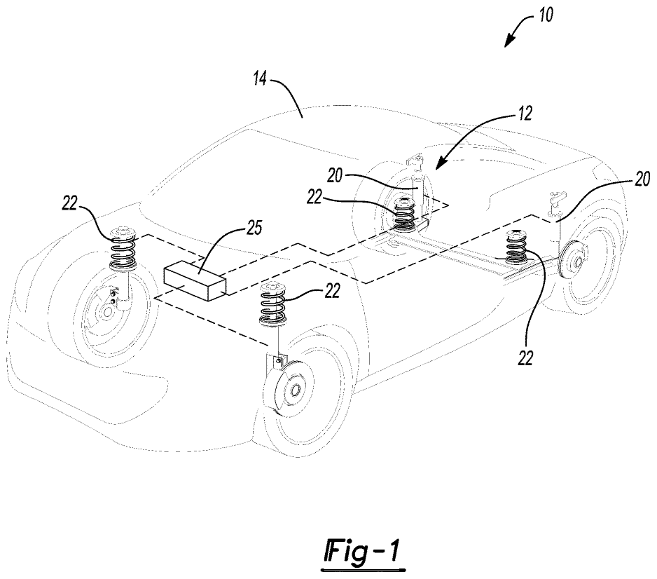

FIG. 1 illustrates an exemplary vehicle 10 including a suspension system 12 and a body 14. Suspension system 12 includes dampers figures0 and coil springs 22. The dampers 20 may be semi-active with damping levels controlled by an electronic control unit 25. Electronic control unit 25 receives information such as acceleration, displacement, steering angle, brake applications, and vehicle speed from sensors (not shown).

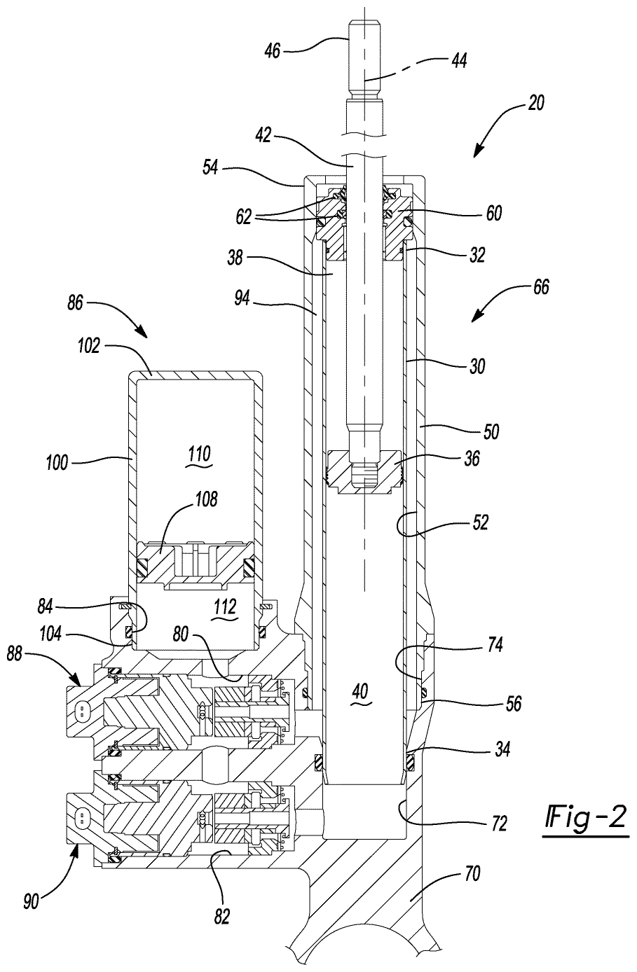

FIG. 2 illustrates exemplary damper 20, which has a mono-tube arrangement for gas and oil separation. Damper 20 may be any one of the dampers 20 of vehicle 10. Damper 20 may optionally be configured as a Continuously Variable Semi-Active Suspension System Damper. Damper 20 contains a fluid, that by way of example and without limitation, may be a hydraulic fluid or oil. Damper 20 includes an inner tube 30 that extends longitudinally between a first inner tube end 32 and a second inner tube end 34. A piston 36 is slidably disposed within inner tube 30. Piston 36 defines a first working chamber 38 and a second working chamber 40 within inner tube 30. Each of the first and second working chambers 38, 40 contain the fluid therein.

First working chamber 38 is positioned longitudinally between piston 36 and first inner tube end 32 and acts as a rebound chamber during movement of piston 36. Second working chamber 40 is positioned longitudinally between piston 36 and second inner tube end 34 and acts as a compression chamber. The volume of the first and second working chambers 38, 40 varies based on the movement of piston 36. The piston 36 seals against the inside of inner tube 30. In the example depicted in FIG. 2, piston 36 is free of orifices or passages such that there is no fluid flow through piston 36. Fluid in first working chamber 38 cannot pass through piston 36 into second working chamber 40 or vice versa. However, alternative configurations are contemplated where piston 36 includes valving (not showing) to limit high internal pressures within first and second working chambers 38, 40.

Damper 20 includes a piston rod 42. Piston rod 42 is coaxially aligned with a longitudinal axis 44. One end of piston rod 42 is connected to piston 36 and reciprocates with piston 36. An opposite end of piston rod 42 includes an attachment fitting 46 that is configured to be connected to a component of vehicle 10.

Damper 20 includes an outer tube 50 disposed annularly around inner tube 30 and includes an inner cylindrical surface 52 that faces and is spaced apart from inner tube 30. Outer tube 50 is coaxially aligned with inner tube 30 along longitudinal axis 44. Outer tube 50 extends longitudinally between a first outer tube end 54 and a second outer tube end 56. Piston rod 42 extends longitudinally out through first outer tube end 54.

A rod guide 60 is positioned within outer tube 50 at first outer tube end 54. Rod 42 extends through rod guide 60. Seals 62 are provided within rod guide 60 to prevent fluid from exiting first working chamber 38 through rod guide 60. It should be appreciated that inner tube 30, piston 36, rod 42, outer tube 50 and rod guide 60 may be constructed as a tube and piston sub-assembly 66.

A housing 70 is in receipt of and fixed to tube and piston sub-assembly 66. More particularly, housing 70 includes a bore 72 in receipt of second end 34 of inner tube 30. Housing 70 includes another bore 74 coaxially aligned with bore 72 and in receipt of second end 56 of outer tube 50. Each of the inner tube 30 and the outer tube 50 are sealingly coupled to housing 70. Housing 70 includes a first valve bore 80 and a second valve bore 82 extending substantially perpendicular to longitudinal axis 44. Housing 70 further includes an accumulator port 84 fluidly coupled to and in receipt of an accumulator 86. First of valve bore 80 is in receipt of a first valve 88. Second valve bore 82 is in receipt of a second valve 90.

A fluid transport chamber 94 is disposed between inner tube 30 and outer tube 50. Fluid transport chamber 94 is in fluid communication with first working chamber 38. The fluid communication between fluid transport chamber 94 and first working chamber 38 may be provided via a passageway in rod guide 60 or an aperture extending through inner tube 30. The geometry of the passageway or aperture is not depicted in FIG. 2.

Fluid transport chamber 94 is in fluid communication with first valve bore 80. Second working chamber 40 is in fluid communication with bore 72 and second valve bore 82. Accumulator port 84 is in fluid communication with both of first valve bore 80 and second valve bore 82. First valve 88 is selectively operable to entirely open, entirely close or partially open to control fluid flow from first working chamber 38 and fluid transport chamber 94 to accumulator 86 and second valve bore 82. Similarly, second valve 90 is operable to selectively open, close or partially open to place second working chamber 40 in fluid communication with accumulator 86 and first valve bore 80.

Accumulator 86 includes an end cap 100 including a first closed end 102 and an open opposite second end 104 defining an inner volume 106. Second end 104 is sealingly fixed to housing 70. A floating piston 108 is slidably disposed within end cap 100. Floating piston 108 defines a gas chamber 110 and a fluid chamber 112 on an opposite side of floating piston 108.

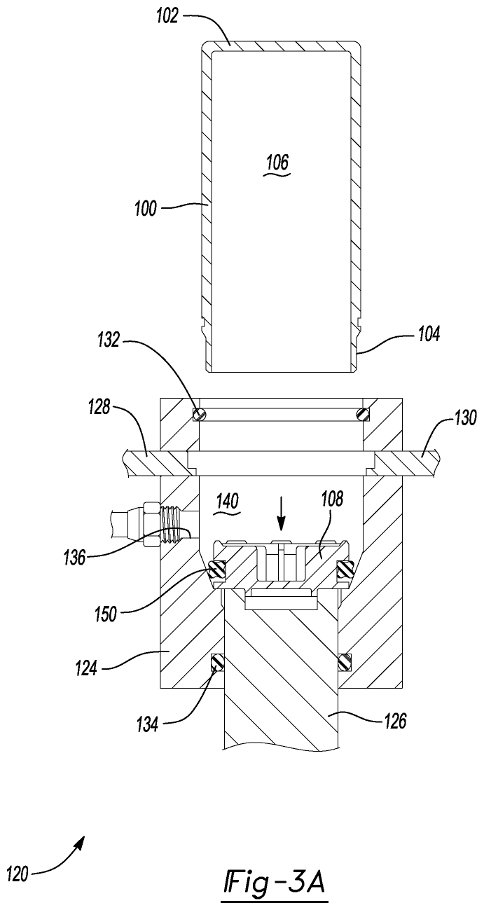

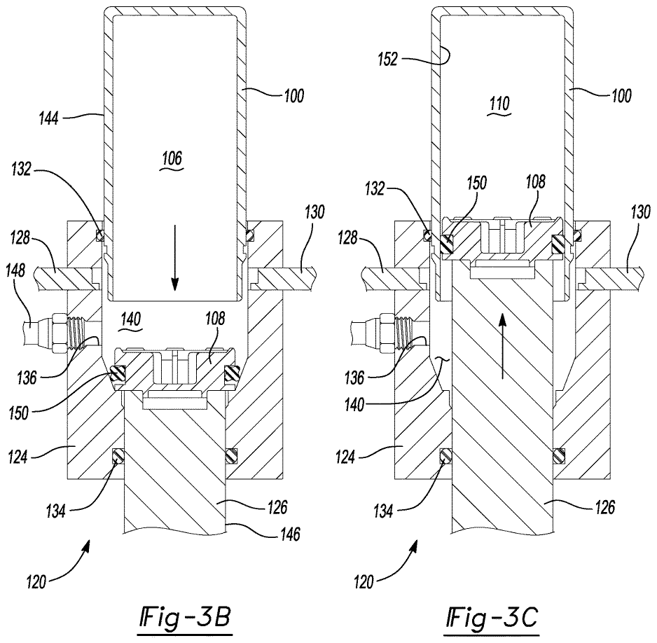

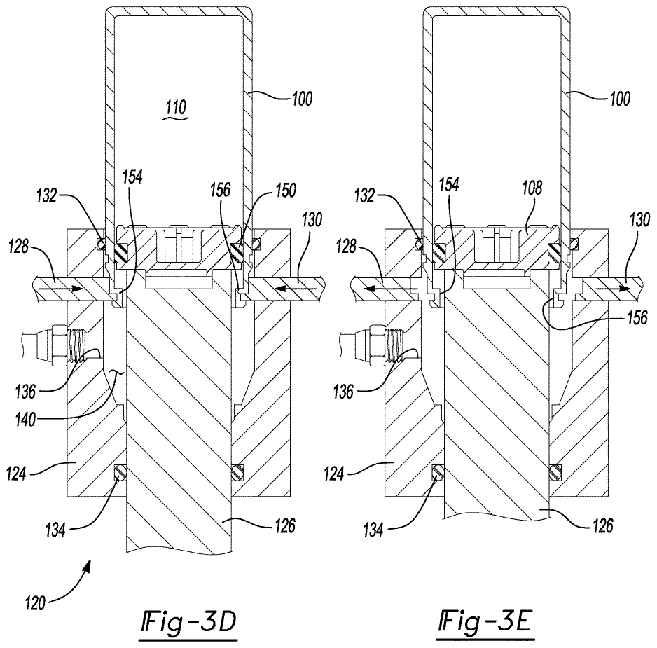

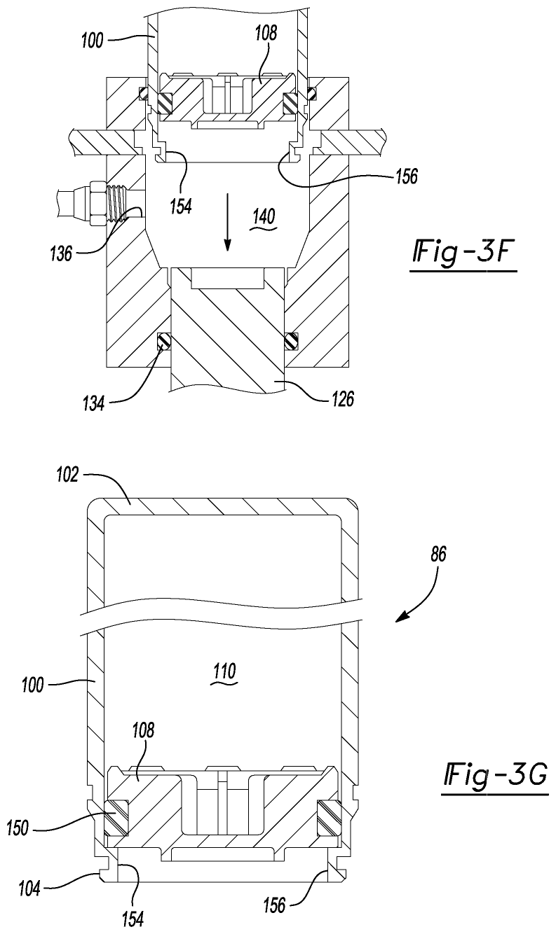

FIG. 3A-3G visually depict a method of pressurizing accumulator 86 including floating piston 108 without the need for a filling port to extend through end cap 100. The pressurizing process begins by placing end cap 100 and floating piston 108 into a work cell 120. Work cell 120 includes a fixture 124, a moveable ram 126, a first translatable jaw 128 and a second translatable jaw 130. A first seal 132 and a second seal 134 are positioned within grooves of fixture 124. A pressurized gas inlet port 136 extends through a wall of fixture 124 to allow gas to be selectively removed from or provided to a cavity 140 of fixture 124.

As shown in FIG. 3B, the method of pressurizing accumulator 86 includes axially translating end cap 100 into cavity 140 and engaging first seal 132 with an outer surface 144 of end cap 100. An outer surface 146 of ram 126 is sealing engaged with second seal 134. Once end cap 100 is positioned as depicted in FIG. 3B, cavity 140 is sealed from the atmosphere. An optional vacuum application step may be performed to evacuate air from end cap 100 and cavity 140. This step may assure that a particular predetermined concentration of gas, such as nitrogen, is stored within accumulator 86 at the completion of the process.

After inserting end cap 100 into fixture 124 and completing the optional step of evacuating cavity 140, pressurized gas is supplied through an external line 148 to port 136 to fill end cap 100 and cavity 140 with a gas, such as nitrogen, to a predetermined pressure.

The process continues at FIG. 3C where ram 126 is axially translated in the direction of the arrow such that floating piston 108 and its associated seal 150 are inserted within end cap 100. At this time, seal 150 sealing engages in inner surface 152 of end cap 100. Pressurized gas chamber 110 is defined during this step. A final target gas pressure within pressurized gas chamber 110 is set by initially pressurizing cavity 140 as depicted in FIG. 3B to a first pressure magnitude and subsequently driving piston 108 via ram 126 a known distance into end cap 100 thereby compressing gas within pressurized gas chamber 110 to the final target gas pressure.

The method of pressuring accumulator 86 continues as depicted in FIG. 3D. While the relative axial positions of floating piston 108, end cap 100 and fixture 124 are maintained as previously depicted in FIG. 3C, first and second translatable jaws 128, 130 are transversely driven toward end cap 100. First jaw 128 engages end cap 100 and forms a first radially inwardly extending indentation 154. A second radially inwardly extending indentation 156 is concurrently formed by second jaw 130. These mechanical deformation processes may be considered swaging or crimping processes. Any number of tools such as first and second translatable jaws 128, 130 may be circumferentially spaced apart from one another about the perimeter of end cap 100. The number of tools or indentations required may correspond to the final target gas pressure within pressurized chamber 110 as well as the goal of maintain floating piston 108 within end cap 100 during the service life of damper 20. Jaws 128, 130 or other suitable swaging tools may include any number of end shapes such as flat or semi-circular surfaces.

As shown in FIG. 3E, once the indentations have been permanently formed, first and second translatable jaws 128, 130 are radially outwardly translated to become disengaged from end cap 100. It should be appreciated that the application of pressurized gas may now be discontinued or at any time after floating piston 108 has been driven into end cap 100 to define pressurized gas chamber 110.

As depicted in FIG. 3F, ram 126 is now axially retracted and disengaged from floating piston 108. Pressurized accumulator 86 may be removed fixture 124 and handled as a pressurized subassembly, as shown in FIG. 3G, that may be moved to another work station within the facility with which it has been manufactured or alternatively shipped to another facility where the accumulator will be used as a subcomponent for damper 20.

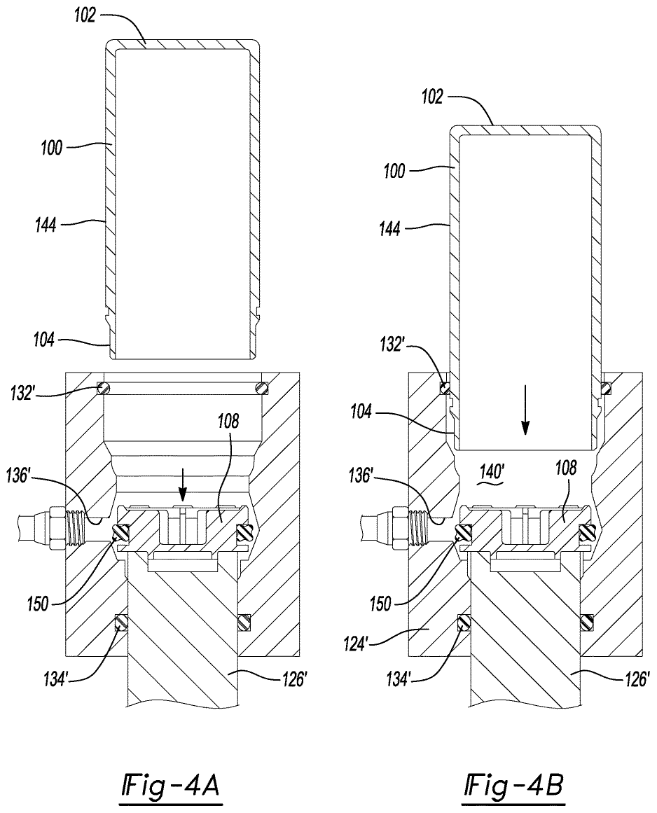

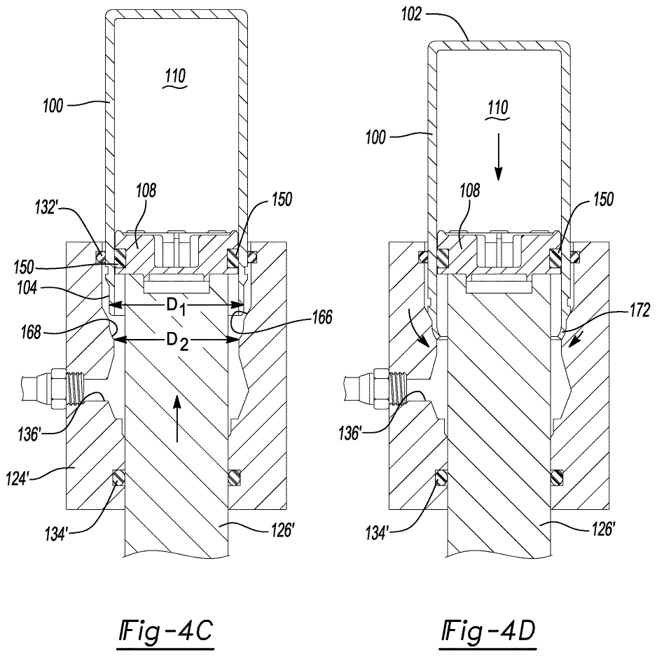

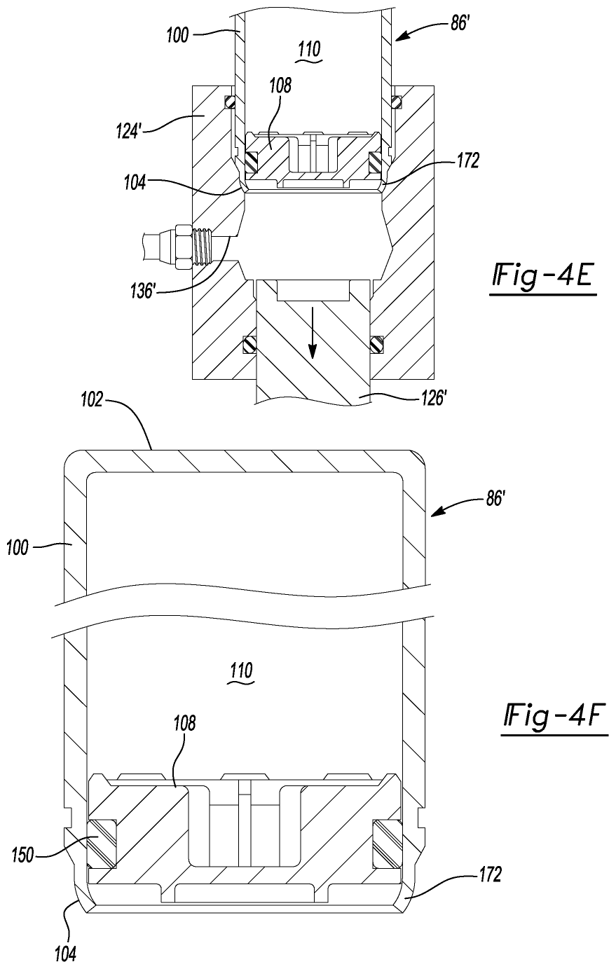

FIGS. 4A-4F depict an alternate process of pressurizing an accumulator. The alternate method depicted in FIGS. 4A-4F is substantially similar to the method previously described in relation to FIGS. 3A-3G. Accordingly, only the substantive differences will be discussed in detail. Several of the elements of the tools or hardware used to execute the alternate process are substantially similar to those previously introduced with relation to FIGS. 3A-3G. The completed accumulator using the alternate pressurizing process is substantially similar to accumulator 86. As such, similar elements will retain their previously introduced reference numerals including a prime suffix.

For example, the steps for pressurizing accumulator 86′, as depicted in FIGS. 4A and 4B, are substantially the same as the steps performed and described in relation to FIGS. 3A and 3B. Floating piston 108 is placed into position on an end surface of moveable ram 126′. Inlet port 136′ is open to atmosphere. At FIG. 4B, end cap 100 is axially translated into a cavity 140′ to a predetermined distance whereat second end 104 remains spaced apart from fixture 124′. After outer surface 144 of end cap 100 sealing engages first seal 132′, pressurized gas is provided through port 136′ to cavity 140′ and the interior volume of end cap 100.

FIG. 4C a step substantially the same as in FIG. 3C. Ram 126′ is axially displaced to position floating piston 108 and its associated piston seal 150 into end cap 100 a predetermined distance to set the final target gas pressure within pressurized gas chamber 110.

Fixture 124′ differs from fixture 124 in that a tapered guide surface 166 radially inwardly extends toward ram 126′. Fixture 124′ also includes a reduction land 168 positioned adjacent to tapered guide surface 166. Reduction land 168 tapers radially inwardly and exhibits an inner diameter identified at reference numeral D₂ that is less than an outer diameter D₁ of end cap 100 at second end 104. Reduction land 168 may be frustoconical in shape or a concave curved surface. Reduction land 168 may be contiguously shaped about the entire circumference of cavity 140′ or may include circumferentially spaced apart portions having reduced diameter D₂.

As shown in FIG. 4D, the process continues by axially driving end cap 100 further into fixture 124 such that second end 104 of end cap 100 is mechanically inwardly deformed as end cap 100 is inserted within fixture 124 a predetermined distance. Second end 104 now exhibits a radially inwardly curved end portion 172. An inner diameter of curved end portion 172 is less than the outer diameter of floating piston 108. Accordingly, floating piston 108 is now restricted from removal from end cap 100.

FIG. 4E illustrates that ram 126 is next retracted from engagement with floating piston 108. An alternate accumulator 86′ having curled end portion 172 as depicted in 4F, may be removed from fixture 124′.

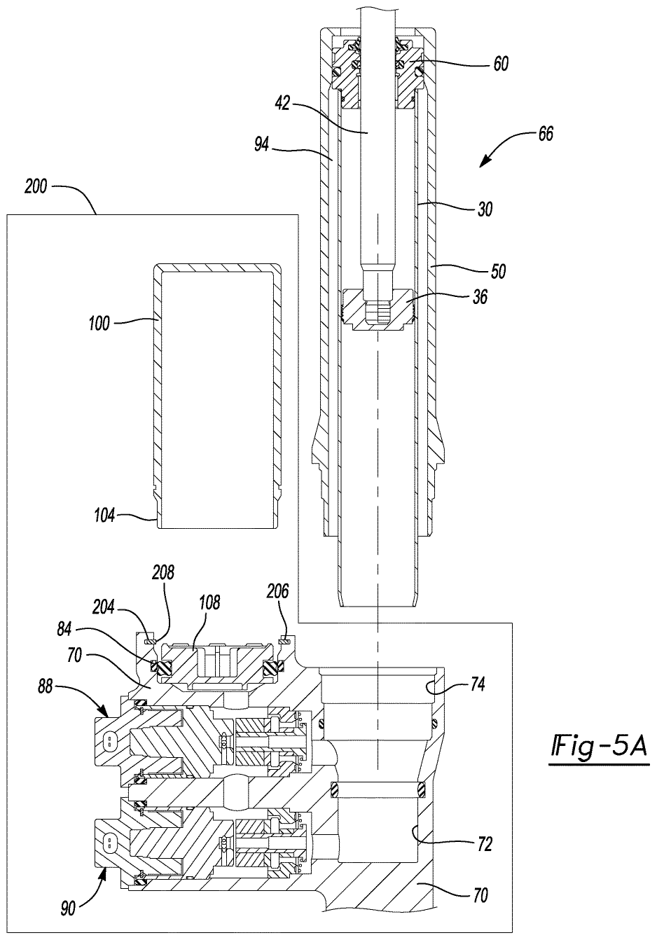

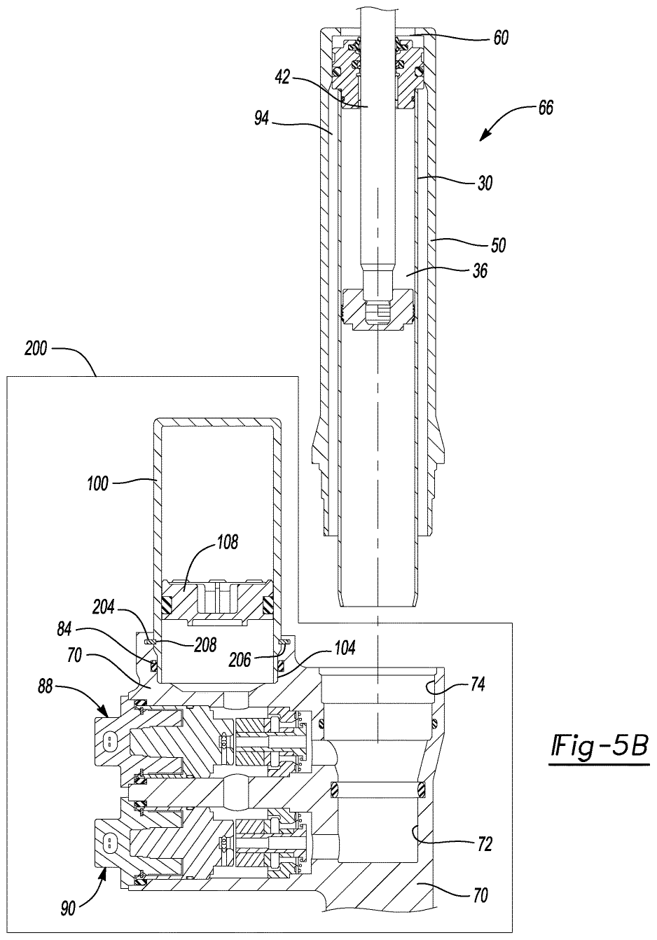

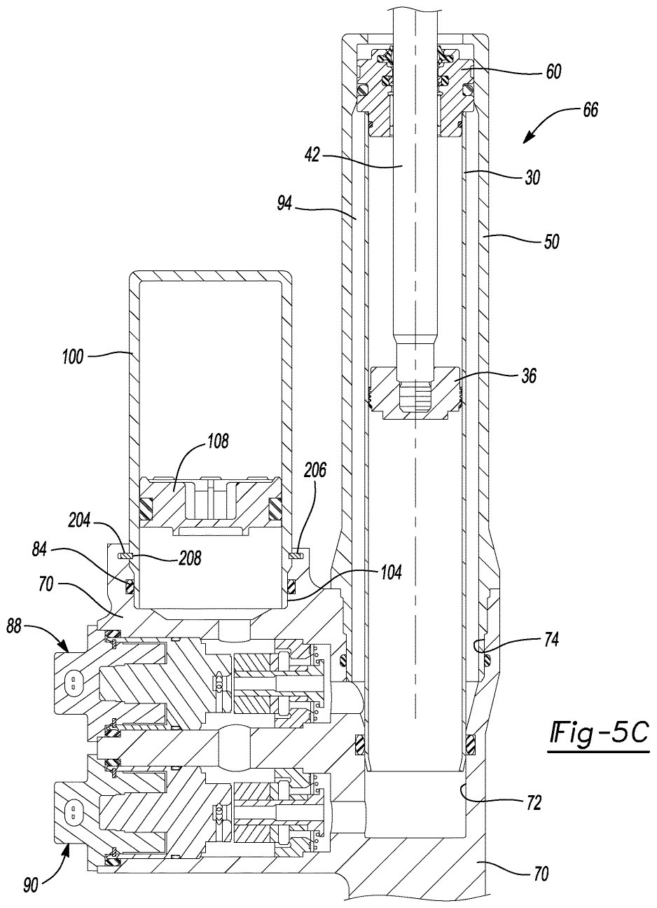

FIGS. 5A-5C depict another alternate method for pressurizing a floating piston accumulator. In this instance, end cap 100 is spaced apart from floating piston 108 and a subassembly of components including housing 70, first valve 88 and second valve 90. Tube and piston subassembly 66 is also spaced apart from these. To perform the method, end cap 100, floating piston 108 and the subassembly of housing 70, first valve 88 and second valve 90 are positioned within a pressurizable container 200, as shown in FIG. 5A. Tube and piston subassembly 66 need not be, but may be, positioned within container 200. While the components positioned within container 200 are spaced apart from one another as previously described, pressurized gas is supplied to container 200.

Subsequently and as depicted in FIG. 5B, end cap 100 is aligned with and translated toward housing 70 to capture floating piston 108 within inner volume 106 of end cap 100. End cap 100 is sealingly fixed with housing 70. In the example shown, seal 84 engages second end 104 of end cap 100. A snap ring 204 is positioned within a groove 206 of housing 70 and a corresponding groove 208 formed on an outer surface of end cap 100. Once end cap 100 contains pressurized gas, contains floating piston 108 and is sealingly coupled to housing 70, the supply of pressurized gas to container 200 may be discontinued.

The subassembly of accumulator 86, housing 70, first valve 88 and second valve 90 may be removed from container 200 as shown in FIG. 5C. Tube and piston subassembly 66 may now be fixed to housing 70 as previously described. Longitudinal axis 44 of subassembly 66 is positioned in parallel with a longitudinal axis of end cap 100. A working fluid, typically a liquid oil may now be pumped into first working chamber 38, second working chamber 40, fluid transport chamber 94, first valve bore 80, second valve bore 82, accumulator port 84, first valve 88 and second valve 90. At this time, the working fluid of damper 20 is in contact with one side of floating piston 108 while pressurized gas within pressurized gas chamber 110 acts on an opposite side of floating piston 108.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A method of pressuring an accumulator for a damper, the damper including a housing, an inner tube, an end cap and a floating piston, the method comprising:
positioning the housing, the end cap and the floating piston within a chamber;
positioning the floating piston outside of an inner volume of the end cap;
supplying pressurized gas to the chamber, wherein the pressurized gas within the chamber enters the inner volume of the end cap through an open end of the end cap;
moving the end cap and the floating piston relative to one another to insert the floating piston through the open end in sealing engagement with the end cap to define a pressurized gas chamber within the end cap;
connecting the end cap to the housing and placing the open end of the end cap in fluid communication with an internal cavity of the housing;
ceasing the supply of pressurized gas to the chamber; and
connecting the inner tube to the housing.

2. The method of claim 1, further including positioning the floating piston within a cavity of the housing prior to supplying pressurized gas to the chamber.

3. The method of claim 1, further including creating a subassembly of the inner tube, an outer tube, a rod guide, a rod and a piston prior to connecting the inner tube to the housing.

4. The method of claim 3, further comprising transferring a liquid to the inner tube and the housing, wherein the liquid contacts a first side of the floating piston and a pressurized gas contacts an opposite of the floating piston after connecting the inner tube to the housing.

5. The method of claim 1, wherein the pressurized gas includes nitrogen.

6. The method of claim 1, wherein the inner tube includes a longitudinal axis and the end cap includes a longitudinal axis positioned parallel to the longitudinal axis of the inner tube after connecting the inner tube to the housing.

7. The method of claim 1, further comprising positioning a first valve within a first bore of the housing, the valve being operable to open and close a passageway to allow and discontinue fluid communication between the first bore and a second bore within the housing.

8. The method of claim 7, further comprising positioning the inner tube within the second bore of the housing.

9. The method of claim 7, wherein the first bore is in fluid communication with the internal cavity of the housing.

10. The method of claim 7, further comprising positioning a second valve within a third bore of the housing.

11. The method of claim 10, wherein the first bore and the third bore extend parallel to one another.

12. The method of claim 1, wherein the end cap, the housing, and the floating piston are removed from the chamber prior to connecting the inner tube to the housing.
